(19) United States
(12) Patent Application Publication
(10) Pub. No.: US 2001/0051858 A1
(43) Pub. Date: Dec. 13, 2001

(54) Method of setting parameters for injection molding machines

(76) Inventors: Jui-Ming Liang, Hsinchu-Hsien (TW); Pei-Jen Wang, Hsinchu City (TW)

Correspondence Address: Jason Z. Lin, 19597 Via Monte Drive, Saratoga, CA, 95070, US

(21) Appl. No.: 09/738,416

(22) Filed: Dec. 15, 2000

(30) Foreign Application Priority Data
Jun. 8, 2000 (TW) 89111159

(51) Int. Cl. G06F 17/10

(52) U.S. Cl. 703/2

(57) ABSTRACT

The present invention is to combine an experimental design method with a moldflow analysis software to simulate the real injection molding processes of the injection molding machine, analyze the simulation results, and develop a database for the quantitative relationship between the parameters of the injection molding machine and the parameters of the injection molding product quality. The database is then used to develop a neural network which can predict the qualities of the injection molding products. The operators of the injection molding machine can input the undetermined parameters to the developed neural network; after execution, the neural network outputs the predicted parameters of the injection molding product quality. The present invention can help the operators to set the parameters, cut down the time on finding appropriate molding parameters, reduce the time of futile try-and-error, and enhance quality by reducing defects.

### BACKGROUND OF THE INVENTION

1. Field of the Invention

The present invention relates to a parameters-setting method for the injection molding machine and, in particular, such a parameters-setting method which employs the moldflow analysis software to simulate the real injection molding processes, to analyze the simulation results, and to develop a database for the quantitative relationship between the parameters of the injection molding machine and the parameters of the injection molding product quality; the database can then be used to train and subsequently develop a neural network that can predict the quality of injection molding products produced by the injection molding machine.

2. Description of the Prior Art

Conventionally, the operators of the injection molding machine set the parameters according to their longtime experience in manipulating the factors such as mold cavities, plastic characteristics, machine performance, and products' defects.

More systematic way of setting parameters for the injection molding machine is using Taguchi method or an experimental design method to develop an empirical model after collecting enough data, and use the model to set parameters accordingly. The weakness of this method is a large amount of time and labor has to be invested before an empirical model can be developed. Another way of obtaining a model is to conduct a series of experiments and then develop a statistical process model that links the parameters of the product quality and the parameters of the injection molding. During the molding process, the statistical relationship can compare the feedback signals of the molding parameters with the real molding parameters on line to produce the optimum parameters. This quality-control technique has reached maturity; however, the shortcoming is that a large amount of time and labor has to be spent during the process of developing a statistical model, and no quantitative relationship can be obtained between the molding parameters and the quality parameters.

Moreover, some expert systems are developed to offer recommendations on the molding parameters to the engineers. The recommendations are based on an IF-THEN method provided by the knowledge database of the expert system. But the expert system has its limitation, for example, no definite relationship between the molding parameters and the quality parameters, and no information beyond the knowledge database can be provided.

Over one thousand patents each year in the past ten years concerning the injection molding processes have been lodged from around the world and the number increases year by year. This increasing trend reveals that the technology of the injection molding is on the rise. Twenty patents concerning the setting parameters of the injection molding are found from around the world (information source: ep.espacenet.com). Among them, the U.S. Pat. No. 5,518,687 is more closely related to the present patent than others; after inputting the given parameters of the injection molding machine, the patent compares the input parameters with the pressure, the speed of the injection molding processes, and the position of the screw, and then modifies the input parameters. The shortcoming of the above approach is that the relation between the appropriate setting parameters and their corresponding process parameters is difficult to obtain. Another patent, the U.S. Pat. No. 5,997,778 adopts a different approach which inputs the given injection speed curve to obtain the dynamic response of the injection molding machine, and use the Proportional Integrator Differentiator (PID) feedback to modify the setting parameters to continuously control the injection molding. The weakness of this method is that only the injection speed can be controlled.

From the above discussions, it is understood that the improvement in setting parameters for the injection molding machine is highly urgent and demanding for the industry to reduce cost as well as enhance the quality of the products.

### SUMMARY OF THE INVENTION

In view of the foregoing background, it is an object of the present invention to provide a system which can conduct real time quality prediction and provide the appropriate ranges of the parameters of the injection molding machine. This, in turn, can help to cut down the time which operators spend on finding appropriate molding parameters, and to smooth the injection molding process.

To achieve the object, the present invention provides a parameter-setting method for the injection molding machine; the method includes the following steps: combine an experimental design method with a moldflow analysis software to simulate the real injection molding processes of the injection molding machine, analyze the simulation resluts, and develop a database for the quantitative relationship between the parameters of the injection molding machine and the parameters of the injection molding product quality; the database is then used to develop a neural network which can predict the qualities of the injection molding products; input the undetermined parameters to the developed neural network; the neural network outputs the predicted parameters of the injection molding product quality.

For more detailed information regarding this invention together with further advantages or features thereof, at least an example of preferred embodiment will be elucidated below with reference to the annexed drawings.

### BRIEF DESCRIPTION OF THE DRAWINGS

The related drawings in connection with the detailed description of this invention, which is to be made later, are described briefly as follows, in which:

FIG. 1 is the flowchart of the present invention;

FIG. 2 is the radial basis function neural network employed in the present invention;

FIG. 3 is the embodiment of the input parameters of the injection molding machine in the present invention; and

FIG. 4 is the embodiment of the output parameters of the injection molding product quality in the present invention.

### DETAILED DESCRIPTION OF THE PREFERRED EMBODIMENT

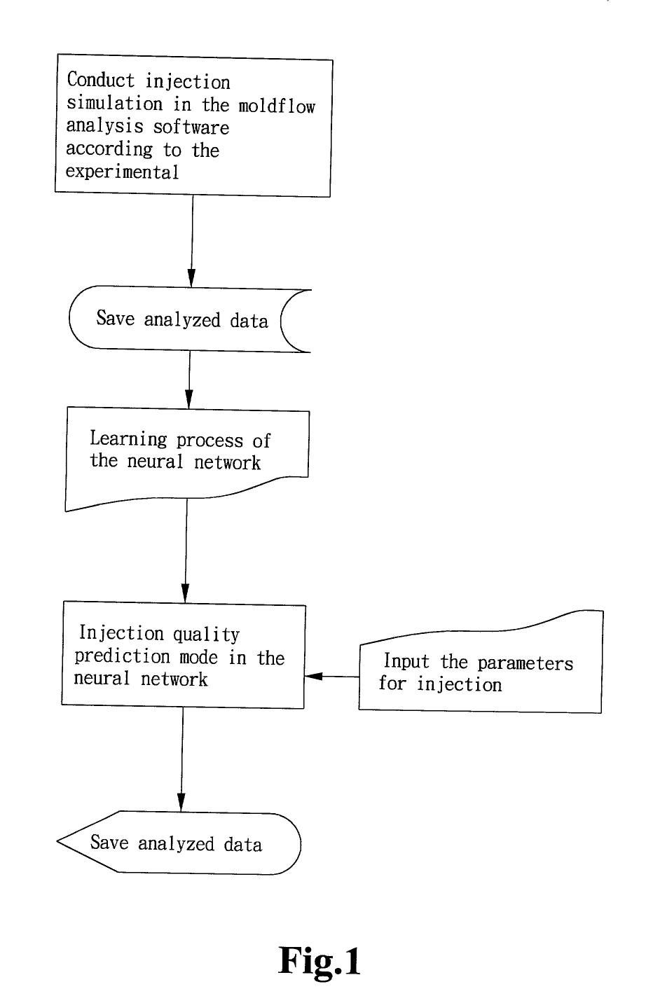

FIG. 1 shows the flowchart of the present invention; the injection molding process is simulated first in the moldflow analysis software according to the experimental design method. One embodiment of the present invention, the experimental design method uses the Taguchi Parameter Design Method and the moldflow software employs the C-MOLD pattern flow software developed by Cornell University. The designed parameters of the injection molding machine can be input into the C-MOLD moldflow analysis software according to the Taguchi Parameter Design Method, to simulate the injection molding processes and subsequently analyze the simulated results, which can then be used to develop the database for the quantitative relationship between the parameters of the injection molding machine and the parameters of the injection molding product quality. The foregoing simulation is carried out with the parameters of the injection molding machine taken to be within the upper and lower thresholds (or parameter window) according to the Taguchi Parameter Design Method, wherein the upper and lower thresholds of the parameters of the injection molding machine are provided by the moldflow analysis software. The analyzed data is then saved to the learning process of the neural network, wherein the learning process of the neural network employs the database to develop a neural network which can then be used to predict the product quality of the injection molding machine. The above parameters of the injection molding machine include at least the cooling time, the pressure-holding time, the held pressure, the injection speed, the molten-plastic temperature, and the mold temperature. The above-mentioned parameters of the injection molding product quality include at least the output weight, the maximum volume shrinkage, the average volume shrinkage, the maximum sink mark, and the average sink mark. On one embodiment of the present invention, the neural network can employ the radial basis function neural network, which will be discussed later.

In FIG. 1, the mode of the neural network predicting the product quality and the input of the parameters of the injection molding machine to the neural network represent inputting the undetermined parameters of the injection molding machine to the developed neural network, wherein the input data are taken within the parameter window. After the execution of the neural network developed in the present invention, the final outputs are the parameters of the injection molding product quality.

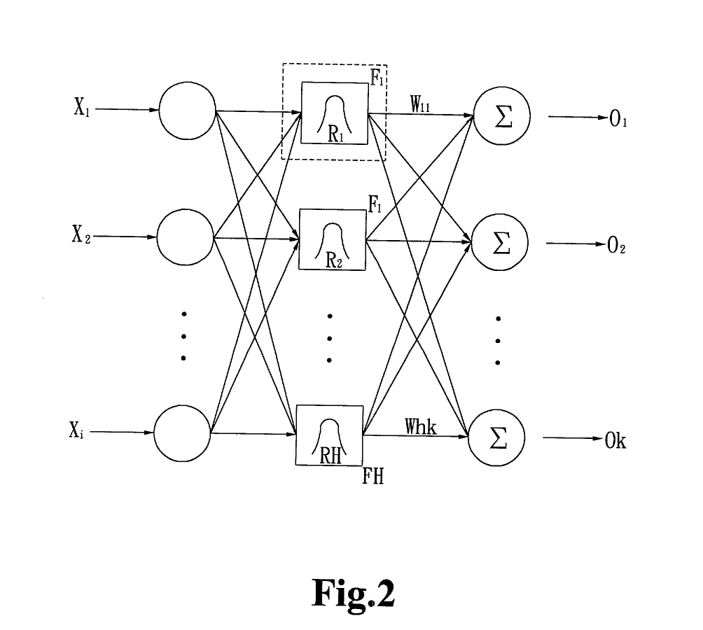

FIG. 2 is the radial basis function neural network employed in the present invention. In FIG. 2, the input-layer parameters of the injection molding machine, X₁, X₂ . . . Xᵢ, are the cooling time, the pressure-holding time, the held pressure, the injection speed, the molten-plastic temperature, and the mold temperature respectively; the output-layer parameters of the injection molding product quality, O₁, O₂ . . . Oᵢ, are the output weight, the maximum volume shrinkage, the average volume shrinkage, the maximum sink mark, and the average sink mark respectively. More than one activation functions, R₁, R₂ . . . R_{H} of the neurons, F₁, F₂ . . . F_{H} can be represented by Gaussian function. W₁₁, Wₕₖ are weights.

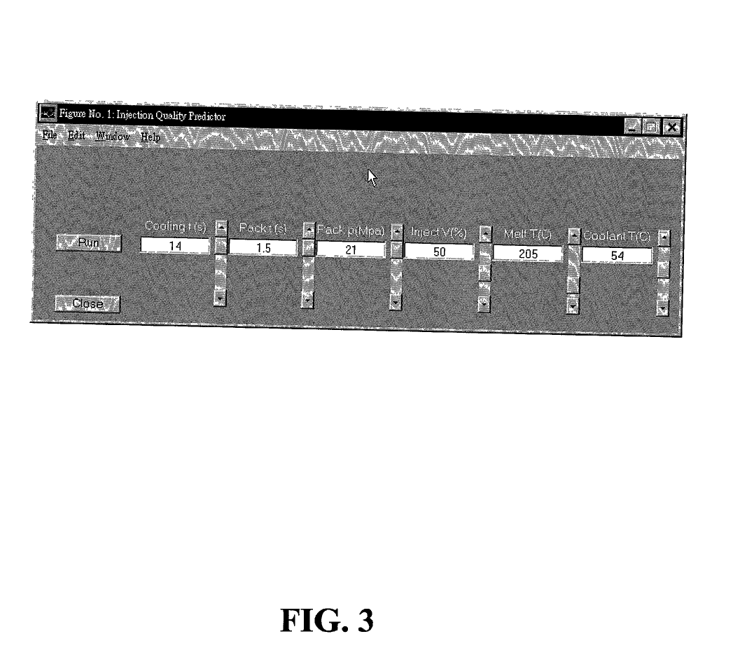

FIG. 3 is one embodiment of the input parameters of the injection molding machine in the present invention. In the embodiment of the present invention, the above-mentioned neural network after being trained and developed can be coded as a software, which can then be run in a computer. FIG. 3 shows operators are setting parameters of the injection molding machine in the parameter window of the software which is coded based on the neural network developed in the present invention.

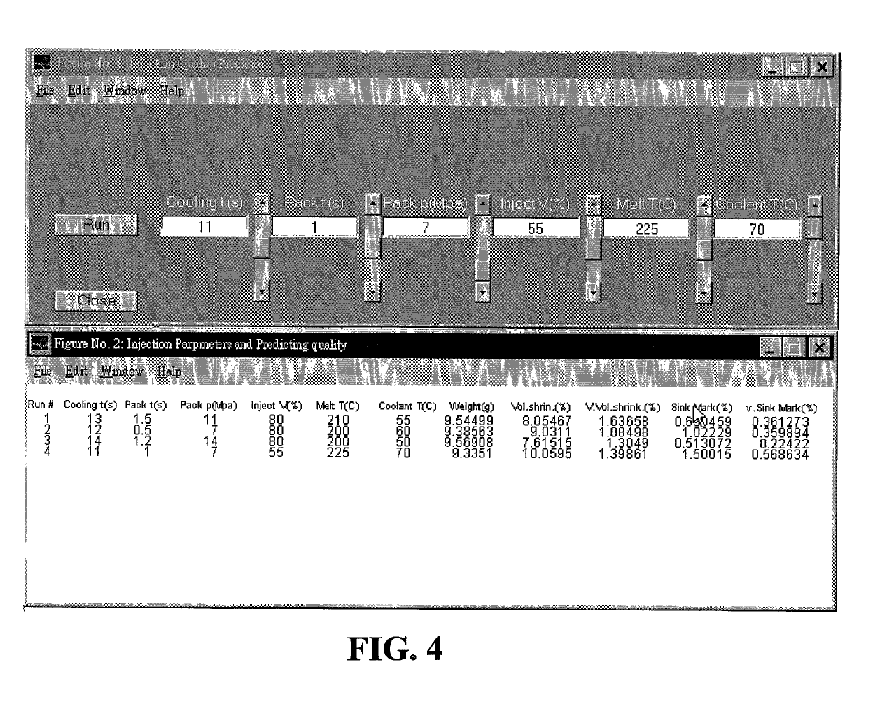

FIG. 4 is one embodiment of the output parameters of the injection molding product quality in the present invention. As shown in FIG. 3, operators input parameters into the executed software based on the neural network developed in the present invention; the output parameters of the injection molding product quality are shown in the computer screen, as shown in FIG. 4.

It should be understood that the above only describes an example of an embodiment of the present invention, and that various alternations or modifications may be made thereto without departing the spirit of this invention. Therefore, the protection scope of the present invention should be based on the claims described later.

What is claimed is:

1. A method of setting parameters for the injection molding machine comprising:
combining an experimental design method with a moldflow analysis software to simulate the real injection molding processes of the injection molding machine, analyze the simulation results, and develop a database for the quantitative relationship between the parameters of the injection molding machine and the parameters of the injection molding product quality;
developing a neural network which can predict the qualities of the injection molding products based on the database;
inputting the undetermined parameters to the developed neural network; outputting the predicted parameters of the injection molding product quality from the injection molding machine.

2. The method of setting parameters according to claim 1, wherein said simulation is carried out with the parameters of the injection molding machine taken to be within the upper and lower thresholds (or parameter window) according to the Taguchi Parameter Design Method; said upper and lower thresholds of the parameters of the injection molding machine are provided by the moldflow analysis software.

3. The method of setting parameters according to claim 1, wherein said parameters of the injection molding machine include at least the cooling time, the pressure-holding time, the held pressure, the injection speed, the molten-plastic temperature, and the mold temperature.

4. The method of setting parameters according to claim 1, wherein said parameters of the injection molding product quality include at least the output weight, the maximum volume shrinkage, the average volume shrinkage, the maximum sink mark, and the average sink mark.

5. The method of setting parameters according to claim 1, wherein said neural network is the radial basis function neural network.
